(19) United States
(12) Patent Application Publication
(10) Pub. No.: US 2007/0267932 A1
(43) Pub. Date: Nov. 22, 2007

(54) Stator for inner rotor type rotating electric machine

(75) Inventor: Masakazu Ashikawa, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/800,873

(22) Filed: May 8, 2007

(30) Foreign Application Priority Data
May 8, 2006 (JP) 2006-129141

(51) Int. Cl. H02K 3/00; H02K 1/00; H02K 1/28

(52) U.S. Cl. 310/216; 310/179; 310/218; 310/259; 310/254

(57) ABSTRACT

A stator for an inner rotor type rotating electric machine including: an annular armature core comprised of a plurality of arcuate segmented cores circumferentially arranged; a bobbin assembly comprised of a plurality of arcuate segmented bobbins arranged circumferentially of the armature core to cover the armature core; and a coil wound around each salient pole portion of the armature core via a coil winding barrel of the bobbin assembly, wherein each segmented bobbin is placed across adjacent segmented cores, and when the armature core is covered with the plurality of segmented bobbins to assemble the bobbin assembly, the plurality of segmented cores that constitute the armature core are restrained and held by the bobbin assembly.

### TECHNICAL FIELD OF THE INVENTION

The present invention relates to a stator for an inner rotor type rotating electric machine using an armature core formed by circumferentially arranging a plurality of arcuate segmented cores so as to abut each other.

### PRIOR ART OF THE INVENTION

A stator used in a magnet type AC generator or an inner rotor type rotating electric machine such as a brushless motor is comprised of an armature core having a structure in which a plurality of salient pole portions protrude radially inward from an annular yoke, and coils wound around the salient pole portions of the armature core via bobbins. A rotor of the rotating electric machine is placed inside the stator, and a magnetic pole thereof faces a magnetic pole surface formed on a tip of each salient pole portion of the armature core.

Generally, an armature core is produced by laminating a plurality of steel sheets stamped into a shape having portions for a yoke and salient pole portions and fastening the laminated steel sheets with fasteners such as rivets, or by successively connecting and laminating a series of steel sheets by a progressive lamination method.

The progressive lamination method is a known method in which a connecting portion having a protrusion in one surface of a stamped steel sheet and a recess in the other surface is formed by making parallel cuts in part of the steel sheet and bending a portion between the cuts in the step of stamping the steel sheet, and in laminating a steel sheet stamped later on a steel sheet stamped earlier, a protrusion of a connecting portion formed in the steel sheet stamped later is press fitted in a recess of a connecting portion of the steel sheet stamped earlier, and thus stamped steel sheets are successively connected and laminated.

When a rotating electric machine is relatively small, a diameter of an armature core is small, and a die used for stamping the armature core may be small. Thus, the armature coil can be formed simply by laminating annular steel sheets stamped into a shape having a contour corresponding to a contour of the entire armature core.

However, when a large rotating electric machine is required for generating a large output from the rotating electric machine, a diameter of an armature core is significantly large. To stamp an annular steel sheet that forms the armature core at a time, a large steel sheet stamping device needs to be prepared, which increases production costs.

Thus, when a stator is large, an armature core is circumferentially divided into a plurality of segmented cores. The armature core of segmented structure has a structure in which a plurality of arcuate segmented cores having a plurality of salient pole portions protruding radially inward from arcuate yokes are circumferentially arranged so that adjacent ends of yokes of the segmented cores abut each other.

FIG. 7 shows a construction of a half part of an armature core of segmented structure. In FIG. 7, a reference numeral 1 denotes segmented cores that are four-divided parts of the annular armature core. FIG. 7 shows two of the four segmented cores 1 in all. Each segmented core 1 is comprised of laminated steel sheets stamped into a predetermined shape, and has an arcuate yoke 101 with a pole arc angle of 90°, and a plurality of (six in the shown example) salient pole portions 102 protruding radially inward from an inner peripheral portion of the yoke 101.

In the shown example, each segmented core 1 is comprised of three blocks B1 to B3 axially laminated. A yoke portion of the middle block B2 has one circumferential end protruding beyond circumferential ends of the other two blocks B1 and B3, and the other circumferential end recessed inward from circumferential ends of the other two blocks. This forms a protrusion 103 at one circumferential end of the segmented core and a recess 104 at the other end. Though not shown, two more segmented cores 1 formed in the same manner are provided, these four segmented cores are circumferentially arranged so that ends of adjacent segmented cores abut each other, and a protrusion 103 of one of two adjacent segmented cores is fitted in a recess 104 of the other to form an annular armature core 2. In the shown example, the adjacent segmented cores are fastened by iron fastening means 105 such as rivets or through bolts, and connected so as not to be separated.

In FIG. 7, a reference numeral 3 denotes a bobbin assembly mounted to the armature core for insulating a portion of the armature core 2 around which a coil is wound (a coil winding portion of the salient pole portion 102). The bobbin assembly 3 is provided for each segmented core of the armature core, and has segmented bobbins 300 of the same number as the segmented cores (four in the shown example), each segmented bobbin 300 being comprised of a first arcuate segmented bobbin half part 300A placed to cover a corresponding segmented core from one axial side (an upper side in FIG. 7), and a second arcuate segmented bobbin half part 300B placed to cover the corresponding segmented core from the other axial side of the segmented core. These segmented bobbins are arranged circumferentially of the armature core so that adjacent ends abut each other to form the bobbin assembly 3. A portion of the bobbin assembly 3 covering each salient pole portion of the armature core forms a coil winding barrel 301, and an unshown coil is wound around each coil winding barrel.

As described in Japanese Patent Application Laid-Open Publication Nos. 10-234144 and 2002-262496, an armature core of segmented structure is originally proposed for facilitating winding of coils around a plurality of salient pole portions. This structure is also useful for facilitating production of an armature core in a stator for a large rotating electric machine.

When the segmented core structure is adopted for facilitating winding of a coil around each salient pole, segmented cores are connected after the coil is wound around each salient pole to assemble an annular armature core. However, when the segmented core structure is adopted for facilitating production of a large armature core, the coil does not always need to be wound first, but may be wound after the assembly of the armature core. When the large armature core is used, a flyer of a coil winding machine can be easily inserted therein, thereby allowing winding of the coil even after the assembly of the armature core.

In the stator for an inner rotor type rotating electric machine using the conventional armature core of segmented core structure, the adjacent segmented cores are connected by the fastening means 105 such as rivets, but connecting the segmented cores with iron rivets or the like causes steel sheets that form the segmented cores to be connected in a laminated direction, which may cause eddy current loss and increase loss of the rotating electric machine.

Also, fastening the adjacent segmented cores with the fastening means increases the number of assembly steps of the armature core for the fastening operation, thereby increasing production costs.

### SUMMARY OF THE INVENTION

An object of the present invention is to provide a stator for an inner rotor type rotating electric machine in which an armature core can be assembled without connecting adjacent segmented cores with fastening means such as rivets.

The present invention is applied to a stator for an inner rotor type rotating electric machine including: an annular armature core having a structure in which a plurality of arcuate segmented cores having a plurality of salient pole portions protruding radially inward from arcuate yokes are circumferentially arranged so that adjacent ends of the yokes abut each other; a bobbin assembly having a structure in which a plurality of arcuate segmented bobbins placed to cover the armature core are arranged circumferentially of the armature core, and having a portion that covers each salient pole portion of the armature core forming a coil winding barrel; and a coil wound around each salient pole portion of the armature core via the coil winding barrel of the bobbin assembly.

In the present invention, each segmented bobbin is placed across adjacent segmented cores, and when the armature core is covered with the plurality of segmented bobbins to assemble the bobbin assembly, the plurality of segmented cores that constitute the armature core are restrained and held in an annularly arranged state by the bobbin assembly.

Generally, a bobbin assembly of segmented structure is used that is divided axially of an armature core. The bobbin assembly of segmented structure has a structure in which a plurality of segmented bobbins are arranged circumferentially of the armature core, each segmented bobbin being comprised of a first arcuate segmented bobbin half part placed to cover the armature core from one axial side of the armature core, and a second arcuate segmented bobbin half part placed to cover the armature core from the other axial side, and has a portion that covers each salient pole portion of the armature core forming a coil winding barrel. Also in this case, each segmented bobbin is placed across adjacent segmented cores, and when the armature core is covered with the first and second segmented bobbin half parts that constitute the segmented bobbin to assemble the bobbin assembly, the segmented cores that constitute the armature core are restrained and held in an annularly arranged state by the bobbin assembly.

As described above, each segmented bobbin is placed across the adjacent segmented cores, and when the armature core is covered with the plurality of segmented bobbins to assemble the bobbin assembly, the plurality of segmented cores that constitute the armature core are restrained and held in the annularly arranged state by the bobbin assembly. Thus, the adjacent segmented cores need not to be connected by fastening means such as rivets, thereby preventing an increase in eddy current loss caused by connecting steel sheets that form the armature core in a laminated direction with fastening means such as rivets, and reducing loss of the rotating electric machine.

With the above described construction, the step of fastening the segmented cores is unnecessary, thereby reducing the number of production steps and production costs.

As described above, according to the present invention, each segmented bobbin is placed across the adjacent segmented cores, and when the armature core is covered with the plurality of segmented bobbins to assemble the bobbin assembly, the plurality of segmented cores that constitute the armature core are restrained and held in the annularly arranged state by the bobbin assembly. Thus, fastening means such as rivets conventionally used for connecting the segmented cores can be omitted. This prevents an increase in eddy current loss caused by connecting steel sheets that form the armature core in a laminated direction with fastening means such as rivets, and reduces loss of the rotating electric machine. The step of fastening the segmented cores is unnecessary, the step of fastening the segmented cores is 4unnecessary, thereby reducing the number of production steps and production costs.

### BRIEF DESCRIPTION OF THE DRAWINGS

The above and other objects and features of the invention will be apparent from the detailed description of the preferred embodiment of the invention, which is described and illustrated with reference to the accompanying drawings, in which;

FIG. 1 is a perspective view of an armature core used in an embodiment of the present invention;

FIG. 2 is a perspective view showing one of segmented cores that constitute the armature core in the FIG. 1;

FIG. 3 is a perspective view showing a structure of a half part of a segmented bobbin mounted to the armature core in FIG. 1;

FIG. 4 is a perspective view showing a state where two segmented bobbins are mounted to two segmented cores for illustrating the way of placement of the segmented bobbins in the embodiment of the present invention;

FIG. 5 is a view of winding showing an example of connection of coils wound around the armature core in the embodiment of the present invention;

FIG. 6 is a schematic circuit diagram showing an electrical construction of armature coils formed by the connection in FIG. 5; and

FIG. 7 is a perspective view of half parts of an armature core and a bobbin assembly used in a conventional stator.

### DETAILED DESCRIPTION OF THE PREFERRED EMBODIMENTS

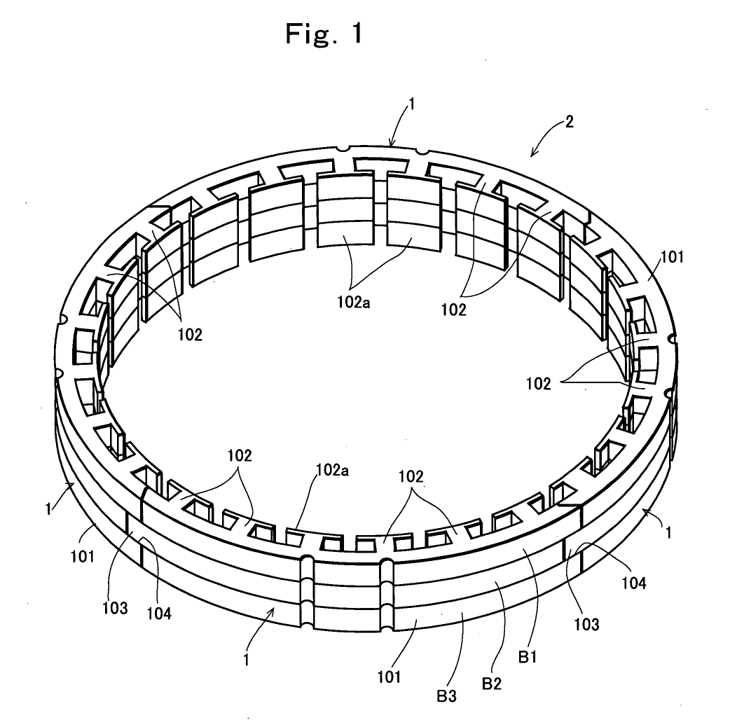

Now, a preferred embodiment of the present invention will be described with reference to FIGS. 1 to 6.

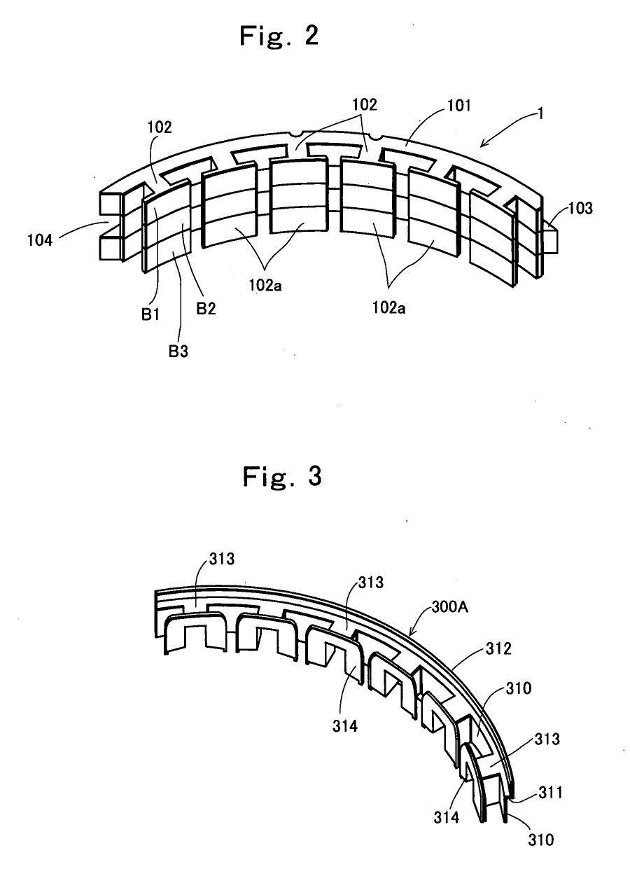

FIG. 1 is a perspective view of a structure of an armature core used in the embodiment. In FIG. 1, a reference numeral 1 denotes segmented cores that are four-divided parts of the annular armature core. As shown in FIG. 2, each segmented core 1 is comprised of laminated steel sheets stamped into a predetermined shape, and has an arcuate yoke 101 with a pole arc angle of 90°, and a plurality of (six in the shown example) salient pole portions 102 protruding radially inward from an inner peripheral portion of the yoke 101. A magnetic pole portion 102a that faces a magnetic pole of an unshown rotor is formed on a tip of each salient pole portion 102.

Each segmented core 1 is comprised of three blocks B1 to B3 axially laminated. A yoke portion of the middle block B2 has one circumferential end protruding beyond circumferential ends of the other two blocks B1 and B3, and the other circumferential end recessed inward from circumferential ends of the other two blocks. This forms a protrusion 103 at one circumferential end of the segmented core and a recess 104 at the other end. The four segmented cores 1 are circumferentially arranged so that ends of adjacent segmented cores abut each other, and a protrusion 103 of one of two adjacent segmented cores is fitted in a recess 104 of the other to form an annular armature core 2 with 24 poles. Iron fastening means such as rivets or through bolts are omitted that are used for connecting adjacent segmented cores in a conventional stator.

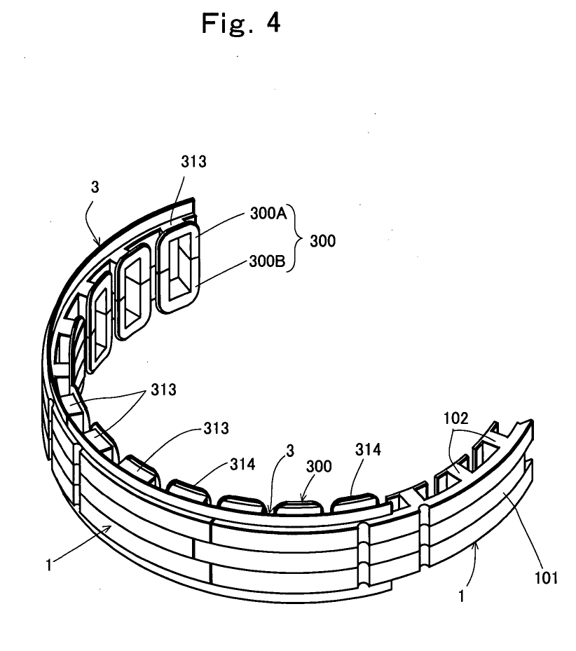

A bobbin assembly 3 of segmented structure as shown in FIGS. 3 and 4 is mounted to the armature core 2 for insulating a portion of the armature core 2 around which a coil is wound (a coil winding portion of the salient pole portion 102). The bobbin assembly 3 has a structure in which four arcuate segmented bobbins 300 are circumferentially arranged, each segmented bobbin 300 being comprised of a first arcuate segmented bobbin half part 300A placed to cover the armature core 2 from one axial side of the armature core 2, and a second arcuate segmented bobbin half part 300B (see FIG. 4) placed to cover the armature core from the other axial side of the armature core 2.

As shown in FIG. 3, the first segmented bobbin half part 300A integrally includes a peripheral wall portion 310 placed to abut an inner peripheral surface of the yoke of the armature core, a flange plate portion 311 placed to abut a portion closer to an inner periphery of an axial end surface of the yoke of the armature core, a standing wall portion 312 axially protruding from an end of the flange plate portion 311 opposite to the peripheral wall portion 310, a coil winding barrel forming portion 313 having a Π-shaped section and protruding radially inward from the peripheral wall portion 310, and a flange plate portion 314 formed on a tip of the coil winding barrel forming portion 311. The second segmented bobbin half part 300B is formed substantially symmetrically with the first segmented bobbin half part 300A, and when the armature core is covered with the first segmented bobbin half part 300A and the second segmented bobbin half part 300B so that the coil winding barrel forming portions 313 thereof abut each other, the coil winding barrel forming portions of the segmented bobbin half parts form a coil winding barrel.

In the present invention, each segmented bobbin 300 is placed across adjacent segmented cores, and when the armature core 2 is covered with the first and second segmented bobbin half parts 300A and 300B that constitute the segmented bobbin 300 to assemble the bobbin assembly 3, the segmented cores 1, 1, . . . that constitute the armature core 2 are restrained and held in an annularly arranged state by the bobbin assembly 3.

FIG. 4 shows a state where two segmented bobbins 300 are mounted to the half part of the armature core comprised of the two segmented cores 1 and 1. In this state, one segmented bobbin 300 is placed across a left half part of the segmented core 1 placed on the right in FIG. 4 and a right half part of the segmented core 1 placed on the left, and a half part of another segmented bobbin 300 covers the left half part of the segmented core 1 placed on the left. In FIG. 4, only two segmented cores 1 are shown, and thus the left half part of the segmented bobbin 300 covering the left half part of the segmented core 1 placed on the left does not cover the segmented core, but actually, the left half part of the segmented bobbin 300 covering the left half part of the segmented core 1 placed on the left covers a further segmented core.

As described above, in the present invention, each segmented bobbin is placed across the adjacent segmented cores, and when the armature core is covered with the plurality of segmented bobbins to assemble the bobbin assembly, the plurality of segmented cores that constitute the armature core are restrained and held in an annularly arranged state by the bobbin assembly. This allows the armature core to be assembled without fastening means such as rivets.

A coil is wound around each salient pole portion 102 of the armature core 2 assembled as described above and to which the bobbin assembly 3 is mounted, via the coil winding barrel formed in the bobbin assembly 3, to complete the stator for a rotating electric machine.

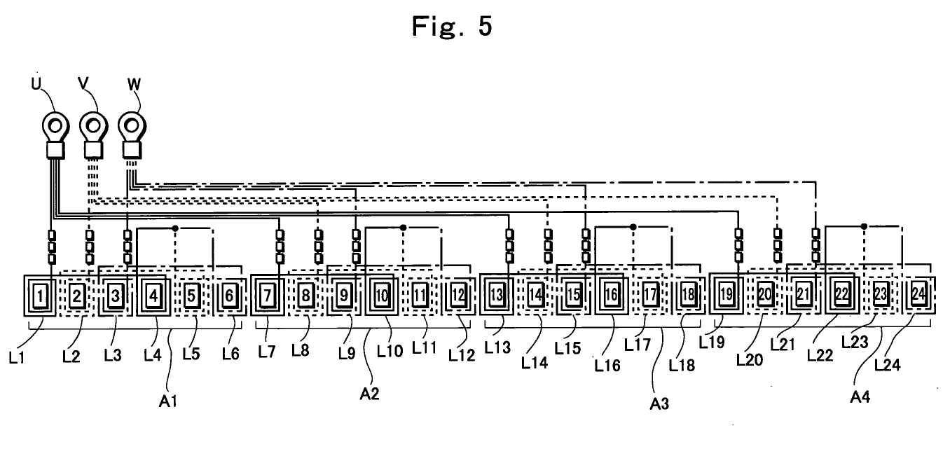

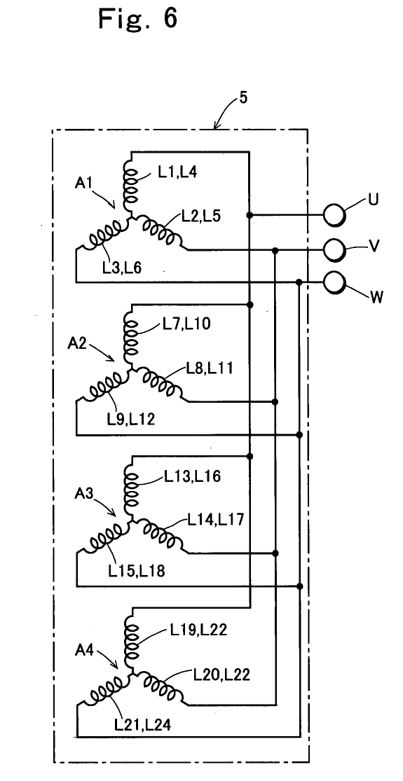

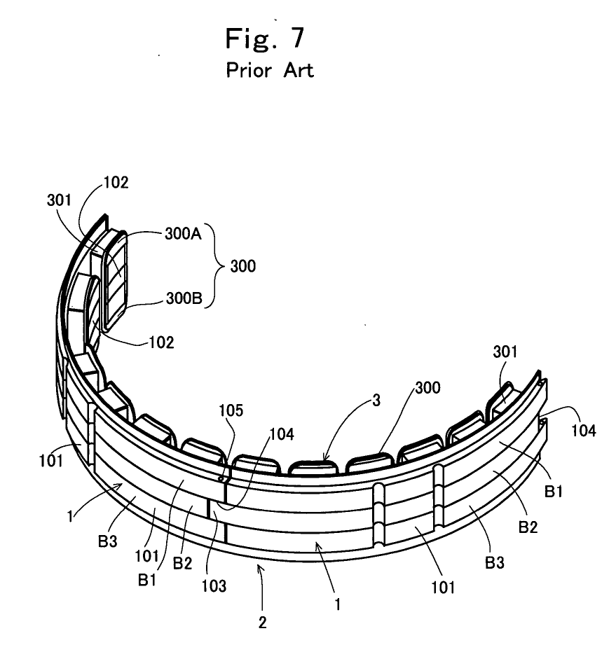

FIG. 5 shows an example of connection of coils wound around the armature core with 24 poles. In this example, coils L1 to L24 are wound around salient pole portions with the numbers of 1 to 24, respectively, and these coils are connected via connecting wires to form a three-phase armature coil 5 star-connected as shown in FIG. 6. In the shown example, a first three-phase coil Al star-connected is comprised of the coils L1 to L6, and a second three-phase coil A2 star-connected is comprised of the coils L7 to L12. A third three-phase coil A3 star-connected is comprised of the coils L13 to L18, and a fourth three-phase coil A4 start-connected is comprised of the coils L19 to L24. The first to fourth three-phase coils A1 to A4 are connected in parallel to form the three-phase armature coil 5 from which terminals U to W are drawn.

The connection of the armature coils is not limited to the above described embodiment, and appropriate connection may be adopted according to use of the rotating electric machine.

In the above described embodiment, the armature core has 24 poles, but the armature core may have any number of salient pole portions.

Although the preferred embodiment of the invention has been described and illustrated with reference to the accompanying drawings, it will be understood by those skilled in the art that it is by way of examples, and that various changes and modifications may be made without departing from the spirit and scope of the invention, which is defined only to the appended claims.

What is claimed is:

1. A stator for an inner rotor type rotating electric machine comprising:
an annular armature core having a structure in which a plurality of arcuate segmented cores having a plurality of salient pole portions protruding radially inward from arcuate yokes are circumferentially arranged so that adjacent ends of the yokes abut each other;
a bobbin assembly having a structure in which a plurality of arcuate segmented bobbins placed to cover said armature core are arranged circumferentially of said armature core, and having a portion that covers each salient pole portion of said armature core forming a coil winding barrel; and
a coil wound around each salient pole portion of said armature core via the coil winding barrel of said bobbin assembly,
wherein each segmented bobbin is placed across adjacent segmented cores, and
when said armature core is covered with said plurality of segmented bobbins to assemble said bobbin assembly, the plurality of segmented cores that constitute said armature core are restrained and held in an annularly arranged state by said bobbin assembly.

2. A stator for an inner rotor type rotating electric machine comprising:
an annular armature core having a structure in which a plurality of arcuate segmented cores having a plurality of salient pole portions protruding radially inward from arcuate yokes are circumferentially arranged so that adjacent ends of the yokes abut each other;
a bobbin assembly having a structure in which a plurality of arcuate segmented bobbins are arranged circumferentially of said armature core, each segmented bobbin being comprised of a first arcuate segmented bobbin half part placed to cover said armature core from one axial side of said armature core, and a second arcuate segmented bobbin half part placed to cover said armature core from the other axial side, and having a portion that covers each salient pole portion of said armature core forming a coil winding barrel; and
a coil wound around each salient pole portion of said armature core via the coil winding barrel of said bobbin assembly,
wherein each segmented bobbin is placed across adjacent segmented cores, and
when said armature core is covered with said first and second segmented bobbin half parts that constitute said segmented bobbin to assemble said bobbin assembly, the segmented cores that constitute said armature core are restrained and held in an annularly arranged state by said bobbin assembly.
